(19) United States
(12) Patent Application Publication
(10) Pub. No.: US 2011/0299389 A1
(43) Pub. Date: Dec. 8, 2011

(54) Real Time Monitoring, Onset Detection And Control Of Congestive Phase-Transitions in Communication Networks

(75) Inventors: Siun-Chuon Mau, Princeton Junction, NJ (US); Alexander Poylisher, Brooklyn, NY (US); Akshaya Vashist, Plainsboro, NJ (US); Ritu Chadha, Hillsborough, NJ (US); Cho-yu Jason Chiang, Clinton, NJ (US)

(73) Assignee: TELCORDIA TECHNOLOGIES, INC., Piscataway, NJ (US)

(21) Appl. No.: 12/957,459

(22) Filed: Dec. 1, 2010

Related U.S. Application Data
(60) Provisional application No. 61/266,649, filed on Dec. 4, 2009.

(51) Int. Cl. H04L 12/56

(52) U.S. Cl. 370/230

(57) ABSTRACT

Systems and methods for managing network congestion through detecting the closeness to network congestion. The network includes a plurality of network nodes, where each node has at least one neighboring node and each node has a buffer for a queue of packets from other nodes. The system measures queue length at a node and the node's neighboring nodes, processes the measured queue lengths to obtain patterns of fluctuations for the measured queue length. The system determines if one or more of the measured nodes are in a transition-onset status toward a phase transition point based on the obtained patterns of fluctuation and generates congestion control signals based on the determination to route network traffic away. The phase transition point corresponds to a change from a non-congestive phase of the measured nodes to a congestive phase of the measured nodes.

### CROSS-REFERENCE TO RELATED APPLICATIONS

This application claims the benefit of the filing date of U.S. Provisional Patent Application No. 61/266,649, filed Dec. 4, 2009, the disclosure of which is hereby incorporated herein by reference.

### BACKGROUND OF THE INVENTION

1. Field of the Invention

The present invention relates generally to systems and methods for congestion control and management in communications networks. More particularly, the present invention relates to detecting congestion onset signals and performing congestion control based on detecting the onset of network phase transitions.

2. Description of Related Art

Present congestion control approaches include traffic engineering and end-to-end congestion control mechanisms. Traffic engineering involves performing traffic status detection and control in a centralized way. Network resources are allocated and load balancing is performed based on established rules as well as expected usage demands. End-to-end congestion control such as TCP focuses on controlling sending rates over source-destination connections. Connection paths are modeled as dynamic data pipes or fixed-path queuing systems and congestion control is performed based on estimated network capacity.

Phase transition theory recognizes that many complex systems have critical thresholds at which the system may shift abruptly from one state to another. These critical thresholds are known as bifurcation points because they bifurcate the system into two contrasting states. Fundamental shifts that occur in systems when they pass bifurcations are known as critical transitions.

Within phase transition science, it is also recognized that some near-universal symptoms may start to appear in a wide class of systems well in advance of the onset of critical transitions. These symptoms indicate that the system is getting close to a critical threshold.

The above notions from phase transition theory have been applied to the studies of communications networks. For example, critical transitions from non-congestion to congestion have been characterized in terms of a relationship between information load of network nodes and the nodes' ability to deliver the information.

Phase transitions of a network from a low to high congestion state have also been measured in terms of average travel time of packets as a function of the packet creation rate in the network. Onset of traffic congestion, as an entry into the congestion phase, has been found to be dependent on how each router in the network chooses a path for the packets in its queue, and an appropriate randomness in path selection can shift the onset of traffic congestion so the network can accommodate more packets.

Some methods of controlling end-to-end packet loss in traffic streams include setting packet output rates at particular network nodes below the critical values corresponding to phase transition points of the node buffer occupancy level. These methods reduce packet loss in a traffic stream of one direction by trading off packet loss in another traffic stream of another direction.

However, the above studies either assume prior knowledge of transition points or detect critical points only upon entry into the congestion phase. Criticality control and avoidance in networks would not be achieved using these prior methods because transition points in most networks are unknown and dynamic.

### SUMMARY OF THE INVENTION

Aspects of the invention provide a network congestion control method and system that detects closeness to a congestion phase and controls the network to avoid the congestion based on the detection.

In one embodiment of the invention, a method is provided for managing network congestion. The network includes a plurality of network nodes, where each node has one or more neighboring node and each node has a buffer for a queue of packets from other nodes. The method comprises measuring queue length at a node and the node's neighboring nodes and processing the measured queue lengths to obtain patterns of fluctuation for the measured queue lengths. The method also comprises determining one or more of the measured nodes are in a transition status toward a phase transition point based on the patterns of fluctuation and generating congestion control signals based on the determination. The phase transition point corresponds to a change from a non-congestive to a congestive phase of the measured nodes.

In one example, measuring queue length comprises sampling queue length at a predetermined sampling frequency within a predetermined time period.

In another example, processing the measured queue length comprises correlating, at different time instances, the queue lengths of the sampled node to obtain an auto-correlation of sampled queue lengths.

In a further example, measuring queue length at the node's neighboring nodes comprises measuring the queue lengths at one or more neighboring nodes within a predetermined or dynamically tuned hop distance to obtain a spatial correlation of the queue lengths.

In one example, processing the measured queue lengths comprises correlating the measured queue lengths of the node and of the one or more neighboring nodes.

In another example, processing the measured queue lengths comprises obtaining a pattern of aggregate fluctuations of the measured queue lengths, the aggregate queue-length fluctuation being measurable by a standard deviation divided by an average of the measured queue length.

In a further example, processing the measured queue lengths further comprises obtaining aggregate fluctuations of the rate of changes of the measured queue lengths.

In yet another example, the method also comprises dynamically tuning the predetermined threshold based on an adaptive learning process.

In a further example, determining the measured nodes in a transition status comprises determining one or more thresholds for each respective one of the one or more obtained patterns of fluctuations.

In another embodiment of the invention, a method is provided for routing a packet in a network. The network includes a plurality of network nodes, where each node has one or more neighboring nodes and each node includes a buffer for queuing self-generated packets and packets received from other network nodes. The method comprises monitoring a queue length at a first node and neighboring nodes within a predetermined, or dynamically tuned, hop range of the first node; and processing the measured queue length to determine patterns of queue length fluctuations. The method also comprises determining whether one or more of the measured nodes is transitioning toward a phase transition point based on the determined fluctuations, and selecting a routing path based on the determination. The phase transition point corresponds to a change from a non-congestive phase of one or more of the monitored nodes to a congestive phase of one or more of the monitored nodes.

In yet a further embodiment of the invention, a method is provided for detecting network congestion. The method comprises monitoring, at a first network node, queue length data associated with buffers associated with the first network node and buffers associated with one or more other network nodes in communication with the first network node. The method also comprises determining, at the first network node, changes in the queue lengths of the one or more other network nodes and the first network node. The method further comprises correlating the changes in the queue length sizes based on a time metric or a distance metric; and determining that a network congestion condition exists if the correlated changes in queue lengths exceed a predetermined threshold.

In one example, the time metric comprises a time window that includes at least a first change in queue length at a first time and a second change in queue length at a second time.

In another example, the distance metric comprises queue lengths of a plurality of other network nodes within a predetermined, or dynamically tuned, distance of the first node.

In a further example, the predetermined threshold comprises a measure of a standard deviation divided by an average of the monitored queue lengths.

In another example, the method comprises measuring aggregate fluctuation in the changes in queue lengths, wherein the aggregate fluctuation comprises of standard deviation divided by an average of the monitored changes in queue lengths.

In one example, the method comprises transmitting a control signal from the first network node to the one or more other networks nodes indicating onset of a network congestion condition if the correlated changes in queue length size exceed the predetermined threshold.

In another example, the method comprises learning through an adaptive learning process; and dynamically tuning the predetermined threshold based on the learning.

In a further example, the first network node is selected from the group consisting of a router and a computer.

In another embodiment of the invention, a communication apparatus in a communication network is provided where the communication network includes a plurality of network nodes. Each respective one of the plurality of network nodes has one or more neighboring nodes and each respective node has a buffer for queuing or buffering packets from other nodes. The communication apparatus is coupled to a first network node, the first network node being one of the plurality of network nodes. The communication apparatus comprises a processor and a memory coupled to the processor. The memory contains instructions executable by the processor. The instructions are executable to measure a queue length at the first node and respective queue lengths at the neighboring nodes; and to process the measured queue lengths to obtain patterns of fluctuation for each measured queue length. The instructions are also executable to determine whether one or more of the measured nodes are in a transition status toward a phase transition point based on the obtained patterns of fluctuation, and to generate congestion control signals based on the determination. The phase transition point corresponds to a change from a non-congestive phase of the measured nodes to a congestive phase of the measured nodes.

In one example, the apparatus comprises instructions executable to correlate queue lengths sampled at a predetermined sampling frequency at the first node; to correlate the measured queue lengths of the first node and those of its one or more neighboring nodes; and to obtain an aggregate fluctuation in the measured queue lengths.

In another example, the apparatus also comprises instructions executable to measure aggregate queue-length fluctuation as standard deviation divided by an average of the measured queue length.

In another example, the apparatus also comprises instructions executable to determine if an average of the patterns of fluctuation is above a threshold of a standard deviation divided by an average of the measured queue length.

### BRIEF DESCRIPTION OF THE DRAWINGS

FIG. 1 illustratively depicts network congestion as a phase transition in a wired network.

FIG. 2 is a system diagram in accordance with aspects of the invention.

FIGS. 3A-B shows a network diagram and apparatus in accordance with aspects of the invention.

FIGS. 4A-C illustrates transition-onset signals for congestive phase transition in a communication network using different traffic sources.

FIG. 5 shows a network data flow in accordance with aspects of the invention.

FIG. 6 is a flow chart in accordance with aspects of the invention.

### DETAILED DESCRIPTION

Aspects, features and advantages of the invention will be appreciated when considered with reference to the following description of exemplary embodiments and accompanying figures. The same reference numbers in different drawings may identify the same or similar elements. Furthermore, the following description is not limiting; the scope of the invention is defined by the appended claims and any equivalents.

In accordance with aspects of the invention, a system of detecting and managing network congestion is provided in a network having a plurality of network nodes. Each node has at least one neighboring node and each node has a buffer queuing packets from other nodes. The system measures queue length at a node and the node's neighboring nodes, processes the measured queue lengths to obtain patterns of fluctuations for each measured queue length. The system determines if one or more of the measured nodes are in a transition status toward a phase transition point based on the obtained patterns of fluctuations and generates congestion control signals based on the determination. The phase transition point corresponds to a change from a non-congestive phase of the measured nodes to a congestive phase of the measured nodes. The congestion control signals may ultimately result in routing network traffic away from congestion points in the network using alternate routes.

As phase transition theory reveals, when a system is getting close to a critical point, a phenomenon called “critical slowing down” occurs. As generally known in dynamic systems, each system is associated with various types of recovery rates so the system may return to an equilibrium state with different speeds from changed conditions due to perturbations. The ability of a system to recover from perturbations becomes increasingly low as the system approaches a bifurcation point. Such slowing down normally starts far from the bifurcation point, and the nearer to a critical threshold, the lower the recovery rate becomes. When the system reaches a particular bifurcation point, the recovery rates become zero.

Although these recovery rates can be easily observed under small experimental perturbations in simulated systems, it is impossible or impractical to systematically test the recovery rates in a real dynamic system. However, the slowing down phenomenon leads to some pattern changes in the system's dynamic properties in advance of the phase transition. These pattern changes signal the slowing down of the system and are generally more easily monitored than recovery rates of a system. As such, these pattern changes can be utilized as onset warning signs that signal the system's closeness to a critical point.

Some of these early warning signs may lie in the time domain. For example, one of the time series signals may include the autocorrelation in the fluctuations of the dynamic properties. When a system is far from a critical point, the recovery rate is relatively high and the dynamic properties of the system may be characterized by weak correlations between the states at subsequent time intervals. However, as the recovery rates of a system decrease, the system's state becomes increasingly like its past state as time advances. Thus, when a system approaches a critical point and the slowness in recovery becomes more evident, the autocorrelation in the system's degrees of freedom increases and approaches from zero to one. A stronger correlation may be observed between states on a degree of freedom (Sₜ₃, Sₜ₂) than the correlation between states on the same degree of freedom (Sₜ₁, Sₜ₀), assuming time advances from t0 to t3 and the differences of the degree of freedom between t3 and t2 and t1 and t0 are the same.

Thus, in a continuous phase transition (CPT, or a so called second-order phase transition, as opposed to first-order phase transition or discontinuous phase transition), auto-correlation means that, degrees of freedom (DoF) measured at two different times at a location in a system tend to be weakly correlated when the system is far from the phase transition point but become strongly correlated when the system gets closer to the transition point.

Some of these early warning signals may be observed in the spatial domain. One explanation of such spatial observables is that many dynamic systems may be viewed as units coupled together where the state of one unit has some influence to that of the unit connected to it. As such, an increased spatial coherence may be observed within the system where more and more connected elements start to exhibit similar states. Cross correlation between these elements thus increases as the system moves toward the critical transition point.

In view of the above, in a continuous phase transition, spatial-correlation means that the degrees of freedom (DoF) measured at two spatially separated locations in a system tend to be weakly correlated when the system is far from the transition point, but become increasingly correlated when the system is closer to the criticality. Thus, when a system approaches a critical point the spatial-correlation (also called cross-correlation) in DoF's, even far away from each other, generally increases and moves from zero to one.

Since different types of systems may be associated with different varieties of spatial patterns, defining spatial observables and spatial ranges or domains to monitor and interpret spatial patterns depends on, to a large degree, the type of the system being observed. For example, in a communications network, it is important to measure spatial correlations within regions experiencing the same underlying traffic conditions. If the network traffic is such that most of the traffic conditions, e.g., congestion, is internal to two spatially separated regions of the network, congestion in one region normally occurs independently of the other, and spatial correlation between DoF's crossing the two regions would be meaningless. As such, in a communications network, neighboring nodes within a few, e.g., two, hops of a node may be treated as having the same underlying traffic conditions and meaningful (as a warning sign of congestive transition) spatial correlations in DoF's across these nodes may be derived.

Another quantity that undergoes significant change upon approaching a continuous phase transition is fluctuation in aggregate DoF. It can also be used as an onset signal indicator. As the system moves toward a critical transition, the impact of perturbations accumulates and as a consequence, variance in the patterns of fluctuations may increase and approach infinity (in practice, infinity means a number on the order of the square of the total number of DoF's in the system). Thus, a larger standard deviation in a time series may signal that the system is being tipped off the original equilibrium state. In a continuous phase transition (CPT), this means aggregate DoF (the sum of all DoF) tends to be weakly fluctuating when the system is far from a transition point but becomes more strongly so when the system is closer to the transition point.

As such, spatial-correlation, auto-correlation and fluctuation in aggregate DoF are three quantities that undergo systematic and significant changes as a continuous phase transition approaches, and can be considered as onset warning signs of any system undergoing a continuous phase transition. Such a system includes a network heading towards a congestion state, which has been recognized as a continuous phase transition with strong evidential support.

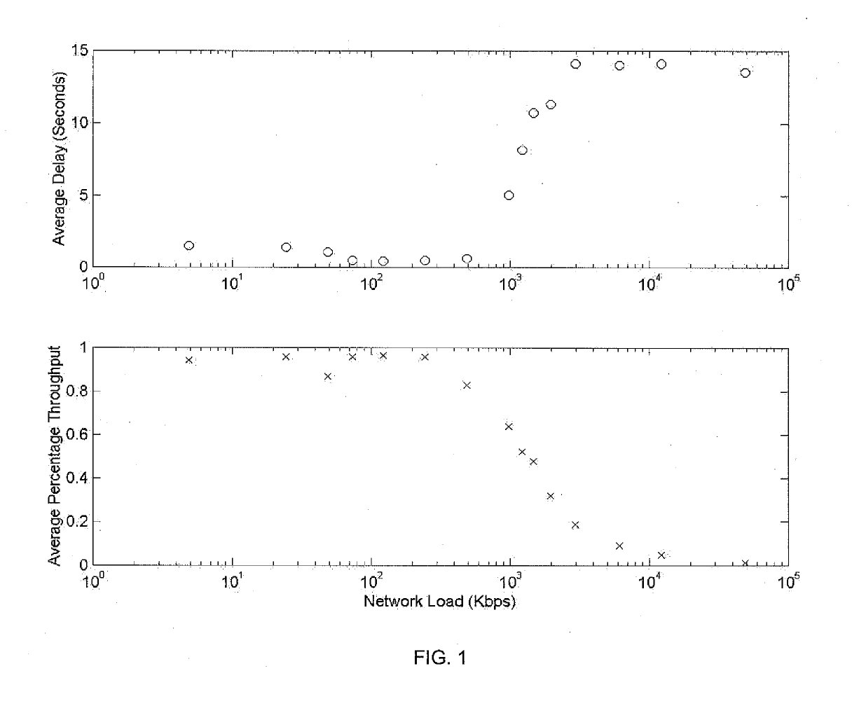

Turning now to FIG. 1, which shows phase transition in a simulated sample wired network in accordance with aspects of the invention. The wired network is constructed with 49 stationary network nodes in a square grid on a 500 meter×500 meter flat terrain. Each network node may reach its four closest neighbors. Forty-nine source-destination pairs are randomly chosen and are fixed. The network nodes, loaded with single class traffic data and each with 300 packets queuing capacity, use a TDMA media access control shortest path routing scheme. Traffic flow is fed by a constant-bit-rate source, and traffic load varies by altering the number of flows per source-destination pair over a predetermined time period. As shown, measurements of average delay and average percentage throughput over the increase of network load offer strong evidence of a phase transition phenomenon.

Thus, with properly selected network raw observables, the spatial-correlation, auto-correlation, and the fluctuation in aggregate of these selected observables may be used as early warning signals to indicate the onset of network congestion, and to be used as control input to drive network congestion and flow control. Wide ranging applicability of onset detection may be based on the universality of continuous phase transition, which denotes that the behavior of a system near a transition does not depend on the details of interactions between the fundamental DoFs. For networks of common spatial dimensionality, this means that the manners in which onset signals grow when the networks approach CPT are nearly identical regardless of other network details.

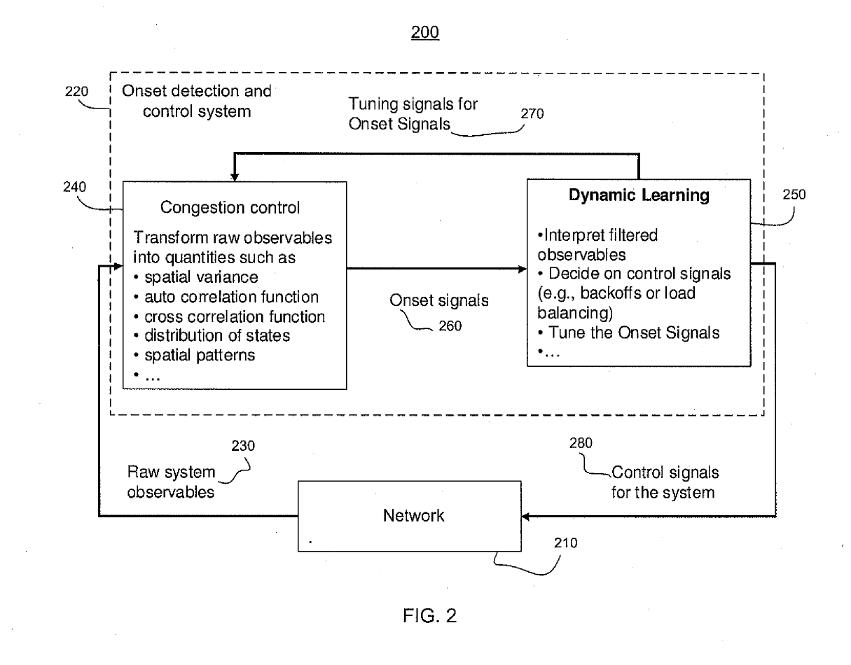

FIG. 2 illustrates a system block diagram 200 in accordance with aspects of the invention. As shown, an onset detection and control system 220 is connected to network 210. System 220 monitors dynamic changes of network 210, take the raw variables as input and analyze the variables using correlation functions. The control signals are then generated based on the analysis and sent to other network entities to perform various network-congestion management, flow control (such as backoff signals to sources) and other functions, so the network could be steered away from moving toward the undesirable congestion phase.

Network 210 may be any type of communications network, for example, a Wi-Fi network in accordance with IEEE 802.x standard, a 3G or 4G cellular network, a wide area network running on Internet Protocol backbone, emerging networks such as LTE, private networks using communication protocols proprietary to one or more companies and various combinations of the foregoing. The network comprises a plurality of network nodes, including, for example, wired or wireless routers, access points forwarding nodes such as repeaters, gateway nodes, application or service hosting nodes, etc.

Various types of dynamic parameters 230 may be observed in network 210. These observables include, but are not limited to, packet queue length or occupancy in the buffer of each routing node, throughput rate, delay, traffic growth, delivery failure rate, packet drop rate etc. These dynamically changing observables reflect local network node as well as network wide changes from one status to another, e.g., from non-congestion to congestion, or vice versa.

Onset detection and control system 220 comprises a congestion control module 240 and a dynamic learning module 250. The congestion control module reads raw observables 230 from network 210, and transforms these raw observables into various types of onset signals 260 that function as indicators of phase transition for the network. The onset signals 260 are input to the dynamic learning module, which generates control signals 280 based on the received onset indicators. The control signals are used to control various network elements to prevent the network transitioning into a congestion phase.

Congestion control module 240 may perform various suitable onset detection functions. As discussed above, spatial-correlation, auto-correlation and fluctuation in aggregate DoF may be used as warning signs of phase-transition onset. Thus, the congestion control module may observe appropriately chosen raw network dynamic parameters (as DoF) at selected sample times, and calculate the spatial-correlation and auto-correlation of these observables. In order to calculate spatial-correlation, locations to observe these DoF's should also be selected.

For example, in a communications network, the fluctuation of queue occupancy level (or queue length) in a receive buffer on a network node may be used as DoF. Thus, the fluctuation of queue occupancy at different time instances may be measured to derive an auto-correlation of the DoF. The fluctuation of queue occupancy measured at two different network nodes at the same time instance may be used to derive a spatial-correlation of the DoF. These three types of measurements are a set of patterns of fluctuations of the measured queue lengths.

Alternatively, the fluctuation of the time rate-of-change of queue occupancy level (or queue length) at a network node may be used as DoF. The auto-correlation of the DoF may thus be obtained by measuring the time rate-of-change of queue occupancy level at different time instances, and the spatial-correlation of the DoF may be obtained by measuring the time rate-of-change of queue occupancy level at different network nodes. These three types of measurements are another set of patterns of fluctuations of the measured queue lengths.

Similarly, for a network domain, the fluctuation of the aggregate DoF may be obtained by measuring the fluctuation of queue occupancy or the time rate-of-change of queue occupancy on all network nodes. The obtained auto-correlation, spatial-correlation and aggregate of the time rate-of-change in queue occupancy level may thus be used as onset signals 260 and output to the dynamic learning system. The aggregate queue-length fluctuation may be approximated by the standard deviation of the queue-length divided by the average queue length.

Upon receiving the onset signals from congestion control module 240, dynamic learning system 250 interprets these signals and generates control signals 280 so the network may perform various congestion and flow control mechanisms.

For example, the control signals may be sent to selected source nodes signaling them to backoff or to start forwarding packets to less loaded nodes, or to update weights assigned to congested links.

The learning system may adopt any suitable learning algorithms, e.g., reinforcement learning method, so the system may gradually improve the onset signal processing and interpretation based on accumulated onset signals. In one example, this module may issue one or more traffic control signals of strengths appropriate for the strength of the onset signal(s) and for the different types of network. The appropriately configured learning systems may also enable the onset signals to be tuned by sending feedback tuning signals 270 to the raw observables transforming process performed by the congestion control module. For example, the values of auto-correlation measurements can depend on a time-window parameter, and can be modified by the learning module.

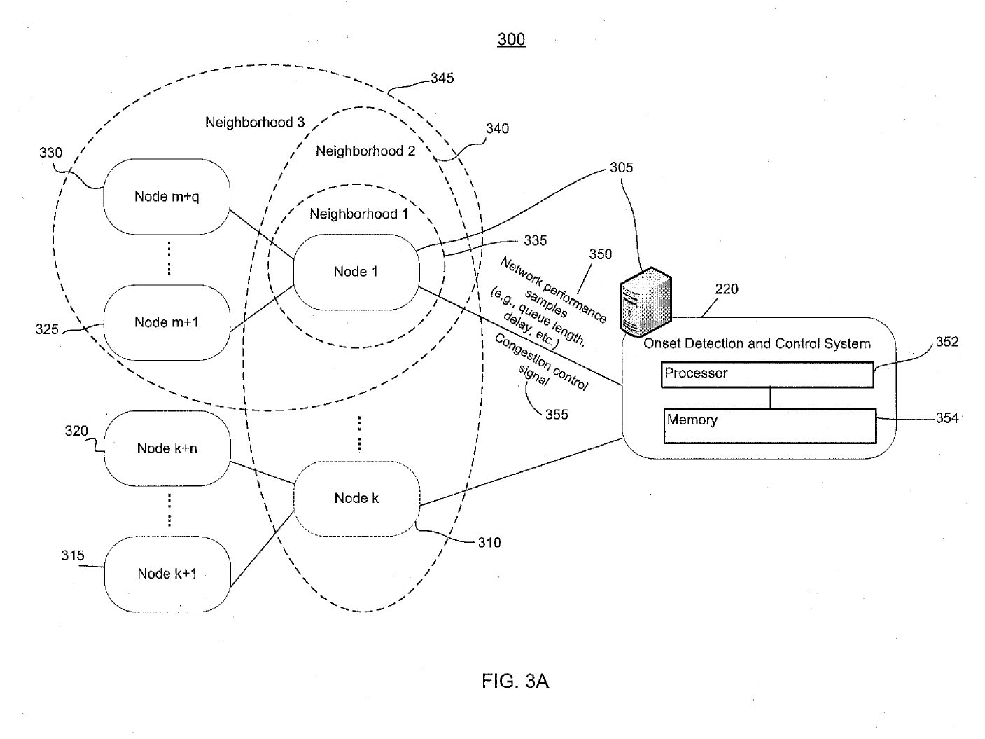

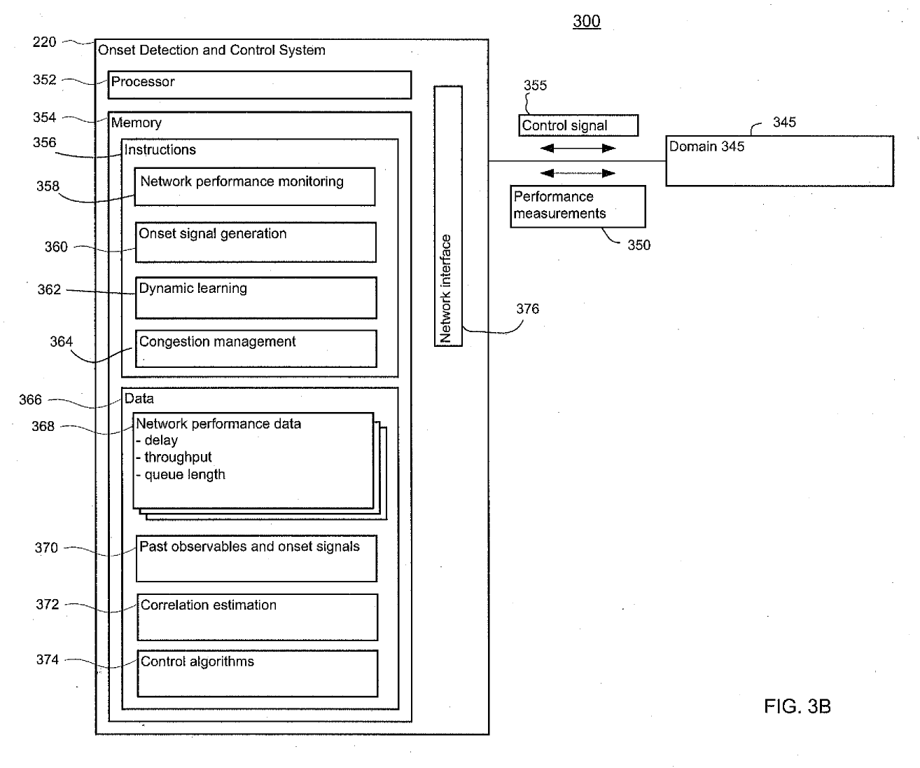

FIG. 3A illustrates a network diagram in accordance with aspects of the invention. System 300 may comprise a plurality of network nodes 305, 310, 315, 320, 325, 330 and 350. In one example, network 300 may be a Local Area Network (LAN) and is configured to execute an Internet Protocol (IP) and a transport protocol such as TCP (Transport Control Protocol). In another example, it may be a mobile network such as a Wi-Fi network running in accordance with IEEE 802.11x standards. The network nodes may be capable of directly and indirectly communicating with other nodes of the network through network interface on each node (not shown), e.g., a network adapter. Each network node may send and receive various types of data, such as Ethernet data, Wi-Fi data, etc.

As shown in FIG. 3A, a phase transition detection and control system 220 in accordance with aspects of the invention may reside on one of the network nodes in network 300, e.g., node 305. As illustrated, node 305 may be configured as a computer server on which the phase transition detection and control system operates. The computer server comprises a processor 352, a memory 354 and other components typically present in general purpose computers. Although FIG. 3A illustrates that only one network node performs onset monitoring and congestion control functions, systems and methods in accordance with the invention may be implemented on selected network nodes or on network node.

In system 300, the phase transition detection and control system may measure one or more network performance variables 350 as DoF at selected network nodes, determine the onset of a congestion state, generates and sends control signal 355 based on the determination back to the network nodes. These performance samples may include, for instance, traffic delay or time rate-of-change of queue occupancies. A generic DoF at a location \vec{r} and time t may be labeled as:

x(\vec{r},t) (1)

If \dot{q} is used to represent the time rate-of-change of queue occupancy at a specific network node (e.g., the DoF at network node 305), the specific DoF may be represented as

\dot{q}(\vec{r}₃₀₅,t) (2)

Thus, at a time instance t, for the two DoF's x(\vec{r}₃₀₅,t) and x(\vec{r}₃₁₀,t) at two locations \vec{r}₃₀₅ and \vec{r}₃₁₀, respectively, the spatial-correlation between them may be obtained by defining a covariance for the two variables:

Γ(\vec{r}₃₀₅,\vec{r}₃₁₀;t)≡cov(x(\vec{r}₃₀₅,t),x(\vec{r}₃₁₀,t)) (3)

The spatial-correlation of the two variables may be further normalized to bound its value from −1 to 1:

G(\vec{r}₃₀₅,\vec{r}₃₁₀;t)≡ρ(x(\vec{r}₃₀₅,t),x(\vec{r}₃₁₀,t)) (4)

where the or Pearson's correlation or the correlation coefficient, ρ(X,Y) between the random variables X and Y, is defined as:

$$ρ ( X , Y ) ≡ \frac{cov ( X , Y )}{\sqrt{cov ( X , X )} \sqrt{cov ( Y , Y )}} \qquad ( 4.5 )$$

The above spatial-correlation in (4) measures how strongly correlated the queue occupancies at network node 305 and network node 310 are. In a continuous phase transition system, the time label t may be dropped in spatial-correlation measures, where the correlations remain constant in time:

G(\vec{r}₃₀₅,\vec{r}₃₁₀)≡ρ(x(\vec{r}₃₀₅),x(\vec{r}₃₁₀)) (5)

Spatial-correlation should be measured at locations within a homogeneous domain. In the general case where a system lacks complete homogeneity, spatial-correlation should be measured for each homogeneous patch of the system. In a communication network, this generally means that all nodes within the homogeneous patch share the same underlying traffic conditions. Hence, unless other information such as traffic flows or offered loads are given, nodes within a predetermined number of (e.g. two) hops may be treated as a homogeneous domain for the purpose of spatial-correlation estimation. Alternatively, if the onset status of a system at a particular length resolution/is desired (e.g., for purpose of monitoring closeness to regional congestion), the system can be partitioned into patches of linear size/and spatial-correlation can be measured for each of those patches.

For instance, in system 300, network nodes from Node 1 to Node k that are within a hop range of k may be designated as a homogeneous domain 340 (Neighborhood 2). Thus, the time rate-of-change of queue length on nodes 1 to k may be measured and normalized with spatial correlation functions. Similarly, network nodes Node 1, and Node m+1 to Node m+q that are within a hop count of q may be defined as domain 345 (Neighborhood 3), and the time rate-of-change of queue length on the network nodes within this domain may be measured and correlated.

When spatial-correlation describes a homogeneous domain of the system in equilibrium, it becomes time-independent and only varies with the distance, r≡|\vec{r}₃₀₅−\vec{r}₃₁₀|, between the two locations \vec{r}₃₀₅ and \vec{r}₃₁₀:

G(|\vec{r}₃₁₀−\vec{r}₃₀₅|)≡ρ(x(\vec{r}₃₀₅₁),x(\vec{r}₃₁₀)) (6)

An equilibrium (with no time label) correlation-length ξ may be defined such that the network nodes with DoF's that are closer together than ξ are considered correlated, while network nodes with DoF's further away from ξ are considered uncorrelated.

As discussed above, auto-correlation may also be measured and used as a signal of congestion onset in the temporal dimension. It may be performed for each individual DoF and hence supports local decisions of a phase-transition onset. Auto-correlation is the correlation coefficient of a given DoF at a location \vec{r} and observed at different time instances t₁ and t₂. In this situation, the location \vec{r} may also be viewed as a domain of itself. For example, in system 300, auto-correlation may be measured on network node 305 in domain 335 (Neighborhood 1). Thus, the correlation coefficient of the time rate-of-change queue length at node 305 observed at time instances t₁ and t₂ is:

R(t₁,t₂;\vec{r}₃₀₅)≡ρ(x(\vec{r}₃₀₅,t₁),x(\vec{r}₃₀₅,t₂)) (7)

Since auto-correlation measures the degree of correlations of a same DoF at two time instances, it is location-independent in a homogeneous domain in which the network nodes share identical traffic conditions. Thus, the location label may be dropped from the above function in a homogeneous domain and the auto-correlation function becomes:

R(t₁,t₂)≡ρ(x(t₁),x(t₂)) (8)

As the spatial correlation measurement depends only on the location difference, auto-correlation depends only on the time difference T≡t₂−t₁(t₂−t₁) if the domain where it is being measured is in a thermal equilibrium. Thus, the above function becomes:

R(T)≡ρ(x(t₁),x(t₁+T)) (9)

where R(T) does not depend on t₁.

An equilibrium correlation time τ may be defined such that the DoF at temporal separations that are shorter than τ are considered correlated, while those at separations longer than τ are considered uncorrelated.

It is well known that, as a network approaches a CPT, both normalized spatial-correlation and auto-correlation grow from small values toward unity, irrespective of spatial and temporal separations. In other words, different parts of a system become more correlated with each other and with time-lagged versions of themselves when they are closer to a CPT. The correlation length ξ and the correlation time τ grow toward infinity as the network approaches the CPT point. For a homogeneous domain, ξ grows to a distance that is on the order of the linear size of entire domain, and τ grows to a time scale that is much longer than the time scale of thermal fluctuation when the network was far from CPT point.

As a network approaches the CPT point from uncongested phase, the domains of the opposite phase (congested phase) grow. These growing domains of congestion phase increase correlation length ξ directly and also increase correlation time τ indirectly, as it becomes more difficult for a DoF on a larger correlated domain to fluctuate.

For a homogeneous network domain such as domain 345, the aggregate DoF (time rate-of-change in queue length) on all network nodes \vec{r} in the domain may be defined as:

$$X ≡ {\sum }_{{r}^{->} ∈ D} x ( {r}^{->} ) \qquad ( 10 )$$

Thus, fluctuation in X, σₓ, is related to spatial-correlation like:

$${σ}_{X}^{2} ≡ 〈 {( X - 〈 X 〉 )}^{2} 〉 = {\sum }_{{{r}^{->}}_{1} , {{r}^{->}}_{2} ∈ D} Γ ( {{r}^{->}}_{1} , {{r}^{->}}_{2} ) \qquad ( 11 )$$

When homogeneous domain 345 is approaching a CPT, spatial-correlations Γ(\vec{r}₁,\vec{r}₂) grow and cause the aggregate fluctuation to grow toward its lower-bounded value at the transition point given by

σₓ²(at transiton point)>∥D∥, (12)

where the lower bound ∥D∥=Σ_{\vec{r}εD} is the number of DoF's in domain D.

For a network under homogeneous traffic condition, σₓ is a measurement indicating the fluctuation between statistically independent but otherwise identical realizations (copies) of the entire network. When every DoF's in the network is strongly correlated with each other, that is, the system has only one spatially correlated domain, σₓ may be measured by averaging over these realizations. When the network has non-unique domains that are weakly correlated with each other (the DoF's within domains are strongly spatially correlated, but those across domains are weakly correlated), σₓ may be approximated by a sample variance of individual DoF's:

$$\begin{matrix}{σ}_{X}^{2} \approx \frac{1}{N} {\sum }_{i = 1}^{N} {( x ( {{r}^{->}}_{i} ) - {m}_{x} )}^{2} \\ where , & ( 13 ) \\ {m}_{X} ≡ \frac{1}{N} {\sum }_{i = 1}^{N} x ( {{r}^{->}}_{i} ) & ( 14 )\end{matrix}$$

is the sample mean of DoF's in the entire network, and N is the number of DoF's in the entire network. As the network approaches the critical point from the uncongested phase, the non-unique spatially correlated domains nucleate. These non-unique domains grow and eventually coalesce into a single spatially correlated domain at the transition point. Since (13) is an average over the entire network and requires uncorrelated domains to remain accurate, it is expected that (13) is a good approximation for the fluctuations as long as the network is not very close to the transition point. The correct measure of fluctuation in (11) grows as the network approaches the critical point from the uncongested phase and reaches its maximum at the critical point. However, due to its approximate nature just explained, the approximate fluctuation measured by (13) grows as criticality is approached, but drops when network becomes very close to criticality due to the reduction in numbers of uncorrelated domains and thereby the breakdown in accuracy of equations (13).

Since spatial correlation and auto-correlation are both examples of covariance, all first, second and cross moments of the covariance should be estimated to obtain real-time measurements. For spatial correlations that are time-independent and with DoF's measured at all locations \vec{r}, including location pair \vec{r}₃₀₅ and \vec{r}₃₁₀, the first, second and cross moments are defined as:

[symbol]

x(\vec{r},t) [symbol] , [symbol] (x(\vec{r},t))² [symbol] and [symbol] x(\vec{r}₃₀₅,t)x(\vec{r}₃₁₀,t) [symbol] (15)

and with time label dropped:

[symbol]

x(\vec{r}) [symbol] , [symbol] (x(\vec{r}))² [symbol] and [symbol] x(\vec{r}₃₀₅)x(\vec{r}₃₁₀) [symbol] (16)

The first and second moments are estimated by:

$$\frac{1}{N} {\sum }_{i = 1}^{N} x ( {{r}^{->}}_{i} ) and \frac{1}{N} {\sum }_{i = 1}^{N} {( ( {{r}^{->}}_{i} ) )}^{2} \qquad ( 17 )$$

respectively, where N is the number of DoF's in the domain of interest.

Cross moment may be estimated by function g(d) at each separation d between DoF's:

g(|\vec{r}₃₁₀−\vec{r}₃₀₅|)≡ [symbol] x(\vec{r}₃₀₅)x(\vec{r}₃₁₀) [symbol] (18)

For a given distance d, location pairs \vec{r}₃₀₅ and \vec{r}₃₁₀ are selected such that the separation between the two locations in each pair is within some predetermined tolerance δ, i.e., d≦|\vec{r}₃₁₀−\vec{r}₃₀₅|≦d+δ and denote the number of such DoF's as N(d; δ). It is implicitly assumed that δ<<d and δ stays the same for each d. A convenient choice for d is the sequence: d₀, d₀+δ, d₀+2δ, . . . , where d₀ may be an empirically selected minimum separation. This is equivalent to binning the separation-distance axis into δ intervals. Thus, the estimate for cross-moment with a separation d is:

$$\frac{1}{N ( d ; δ )} {\sum }_{d \leq \vert {{r}^{->}}_{310} - {{r}^{->}}_{305} \vert \leq d + δ} x ( {{r}^{->}}_{310} ) x ( {{r}^{->}}_{305} ) \qquad ( 19 )$$

Real-time auto-correlation estimation may be similarly performed by estimating the first and second moments of a DoF at location \vec{r} for all t, t₁ and t₂:

[symbol]

x(\vec{r},t) [symbol] , [symbol] (x(\vec{r},t))²) [symbol] and [symbol] x(\vec{r},t₁)x(\vec{r},t₂) [symbol] (20)

with location label dropped:

[symbol]

x(t) [symbol] , [symbol] (x(t))² [symbol] and [symbol] x(t₁)x(t₂) [symbol] (21)

When there are N observations in a finite time window between now and a predetermined time in the past, the first and second moments are estimated by

$$\frac{1}{N} {\sum }_{i = 1}^{N} X ( {t}_{i} ) and \frac{1}{N} {\sum }_{i = 1}^{N} {( x ( {t}_{i} ) )}^{2} \qquad ( 22 )$$

Cross-moment in time [symbol] x(t₁)x(t₂) [symbol] may be measured similar to that in spatial separation by assuming an dependency in time separation |t₂−t₁| only (known as stationarity assumption in statistics). Thus, the time axis is binned into ε intervals. For each time separation T, the observations x(t₂)x(t₁) satisfying T≦|t₂−t₁|≦T+ε (and occurred within the finite time window) are used to estimate the cross moment:

$$\frac{1}{N ( T ; ɛ )} {\sum }_{T \leq \vert {t}_{2} - {t}_{1} \vert \leq T + ɛ} x ( {t}_{2} ) x ( {t}_{1} ) \qquad ( 23 )$$

where N(T; ε) is the number of such observations.

FIG. 3B depicts a more detailed functional diagram of the phase transition detection and control system 220. As shown, the onset detection and control system 220 contains a processor 352, memory 354 and other components typically present in general purpose computers. The system communicates with other network entities, including network nodes within a homogeneous domain 345 through a network interface 376. The network interface may comprise hardware components, circuitries and associated controllers or drivers. The detection and control system may also be implemented on other network nodes as well. As such, network performance samples 350 and control signals 355 may be transmitted between system 220 and other network nodes.

The processor 352 may be any conventional processor, such as processors from Intel Corporation or Advanced Micro Devices. Alternatively, the processor may be a dedicated device such as an ASIC. Although FIG. 3B functionally illustrates the processor and memory as being within the same block, it will be understood by those of ordinary skill in the art that the processor and memory may actually comprise multiple processors and memories that may or may not be stored within the same physical housing. For example, memory may be a hard drive or other storage media or database located in a server farm of a data center. Accordingly, references to a processor or computer will be understood to include references to a collection of processors or computers or memories that may or may not operate in parallel.

Memory 354 stores information accessible by processor 352, including instructions 356 and data 366 that may be executed or otherwise used by the processor 352. The memory 354 may be of any type capable of storing information accessible by the processor, including a computer-readable medium, or other medium that stores data that may be read with the aid of an electronic device, such as a hard-drive, memory card, ROM, and RAM, as well as other write-capable and read-only memories. Systems and methods may include different combinations of the foregoing, whereby different portions of the instructions and data are stored on different types of media.

The instructions 356 may be any set of instructions to be executed directly (such as machine code) or indirectly (such as scripts) by the processor. For example, the instructions may be stored as computer code on the computer-readable medium. In that regard, the terms “instructions” and “programs” may be used interchangeably herein. The instructions may be stored in object code format for direct processing by the processor, or in any other computer language including scripts or collections of independent source code modules that are interpreted on demand or compiled in advance.

The instructions may contain various algorithms, routines and programs, including the network performance monitoring routine 358 used to monitor the raw observables from selected nodes and communication paths in network 300. Onset signal generating routines 360 process the raw network performance samples into onset indicators through functions of auto-correlation, spatial correlation and aggregate fluctuation. These routines may also be configured to set the initial threshold values for the patterns of fluctuations (i.e., auto-correlation function or spatial-correlation and aggregate fluctuations). Each of the patterns of fluctuations may have its own threshold. Dynamic learning (e.g., neural network based learning) algorithms 362) can also be instantiated in the instructions such that the threshold values and correlation functions may be improved over the past performance of the system. Based on the estimated onset indicators, congestion management function 364 generate control signals to be sent to the other network entities.

One implication of using CPT warning signs to detect network congestion is that a-priori knowledge of critical traffic loads is not required for the detection or control of the transition to congestion phase. Another implication is that behavior of congestion warning signs of networks having short-range interactions between DoF's (which is believed to be the case in most networks), such as network 300 illustrated in FIG. 3A, near a CPT does not depend on the details of interactions between the fundamental DoF's, but is only related to spatial dimensionality and the symmetry of order parameter (which is the aggregate DoF for networks). In networks of common spatial dimensionality, manners in which correlation-length and correlation-time grow when approaching CPT are nearly identical, irrespective of other network details. Therefore, if system 220 sets a group of threshold values for spatial-correlation and auto-correlation to implicate the closeness to criticality for network 300, the interpretation of the degree of onset may be similar for other networks. The threshold values may be determined by factors such as the tradeoffs amongst control-response time, network utilization and risk of criticality crossing. These threshold values may also be improved through one or more dynamic learning algorithms such as learning system 262.

The data 366 may be retrieved, stored or modified by processor 352 in accordance with the instructions 356. For instance, although the system and method is not limited by any particular data structure, the data may be stored in computer registers, in a relational database as a table having a plurality of different fields and records, XML documents or flat files. The data may also be formatted in any computer-readable format, and may comprise any information sufficient to identify the relevant information, such as numbers, descriptive text, proprietary codes, references to data stored in other areas of the same memory or different memories (including other network locations) or information that is used by a function to calculate the relevant data.

Data 366 may store various types of data structures or objects accessible by the instructions for congestion onset detection and controls in accordance with the invention. For example, network performance data 368 may include sample performance data collected in temporal dimension from network nodes within the same homogeneous domain (e.g., domain 345). The collected samples may be traffic delay, throughput rate, and queue occupancy changes. Raw network data collected 370, including onset signals generated in the past, may be maintained and used as training data to facilitate the adaptive learning of the system. The data may also include correlation estimation functions 372 and various congestion control algorithms 374. It is not necessary for the above instructions and data to be in the same physical memory. Various types of data may be maintained in databases and/or memories distributed over the network.

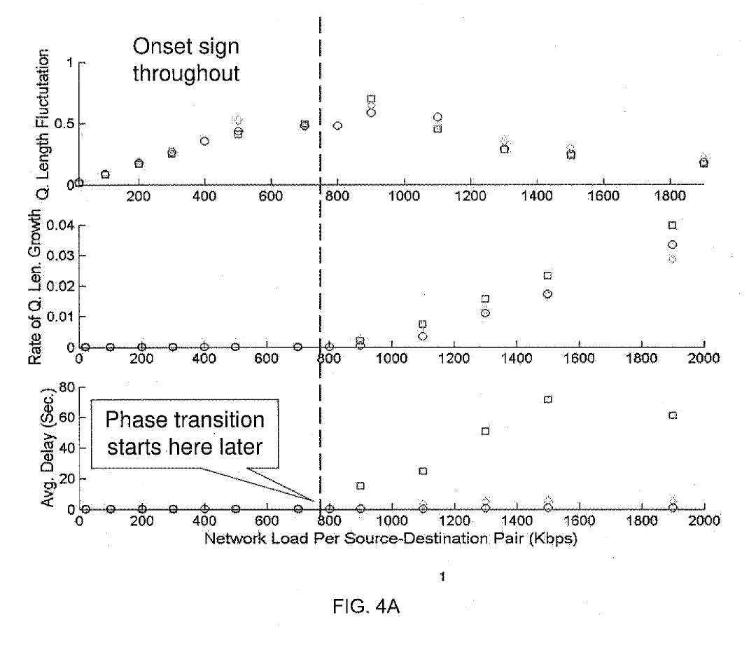

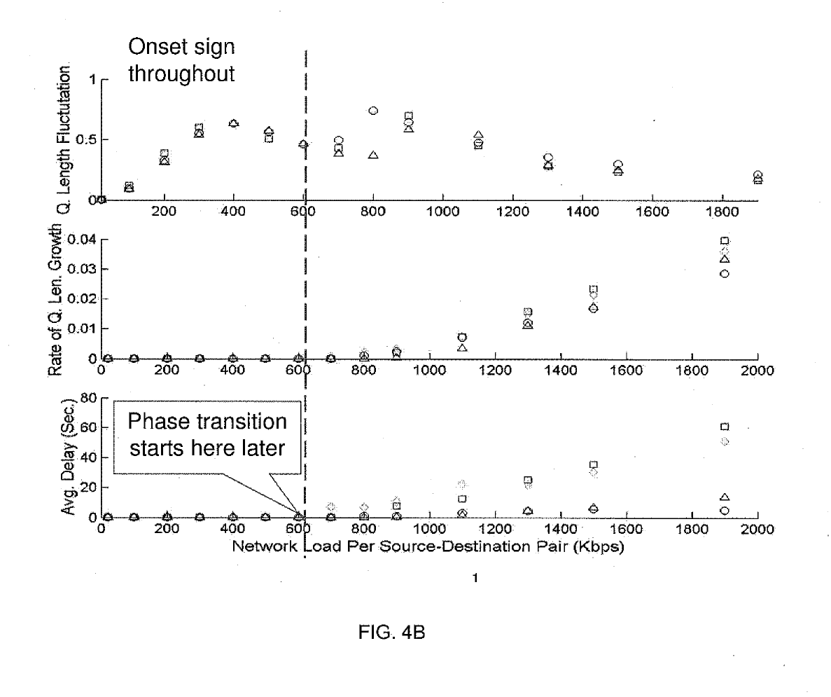

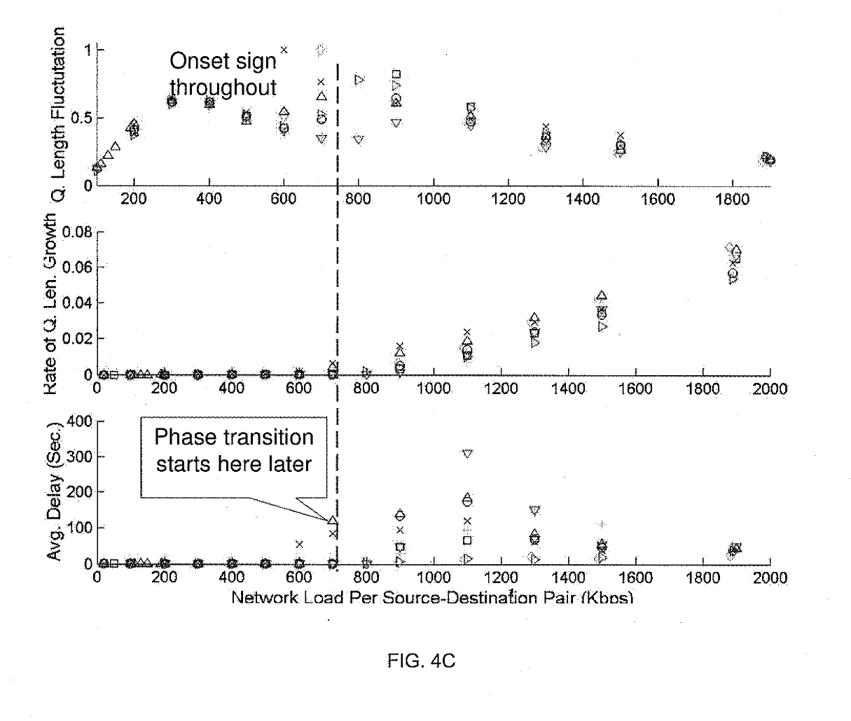

FIGS. 4A-C illustrate early warning signals observed in homogeneous networks with different traffic types and loads. Each figure shows queue-occupancy fluctuation, rate of queue-occupancy growth and average delay. FIG. 4A shows constant-bit-rate source. FIG. 4B illustrates Poisson traffic source. FIG. 4C is long-range-dependent (LRD) traffic.

All these measurements are normalized by the per-node offered load. Queue-length or queue-occupancy fluctuation, in the top plots, is measured by the time average of ratio of sample variance of individual DoF's (13) to (14) and normalized, or divided, by the maximum of this ratio, \sqrt{N−1}, where N is the number of queues in the network domain, which is estimated by assuming that only one queue among all has non-zero occupancy.

Each data point corresponds to a separate simulation at constant offered load and symbols of different shapes correspond to different random-number seeds. Since the rate of queue-occupancy growth indicates which phase the network is in (it is the averaged value of the time-rate of change of individual queue occupancies (2)), it becomes the order parameter of the phase transition. If the per-node offered load is denoted as y, queue occupancy fluctuates close to zero but does not have any long-term growth below the critical load y_{c}. While above the critical load, normalized queue occupancy grows at the non-zero rate of (y−y_{c})/y. When the queue-occupancy fluctuation (top plots) is normalized to vary between a range of 0 to 1, the interpretation of its value as closeness to criticality is universal.

In FIGS. 4A-C, the drop and noisiness in queue-occupancy fluctuation around the critical load may be interpreted as evidence of lack of uncorrelated domains near criticality.

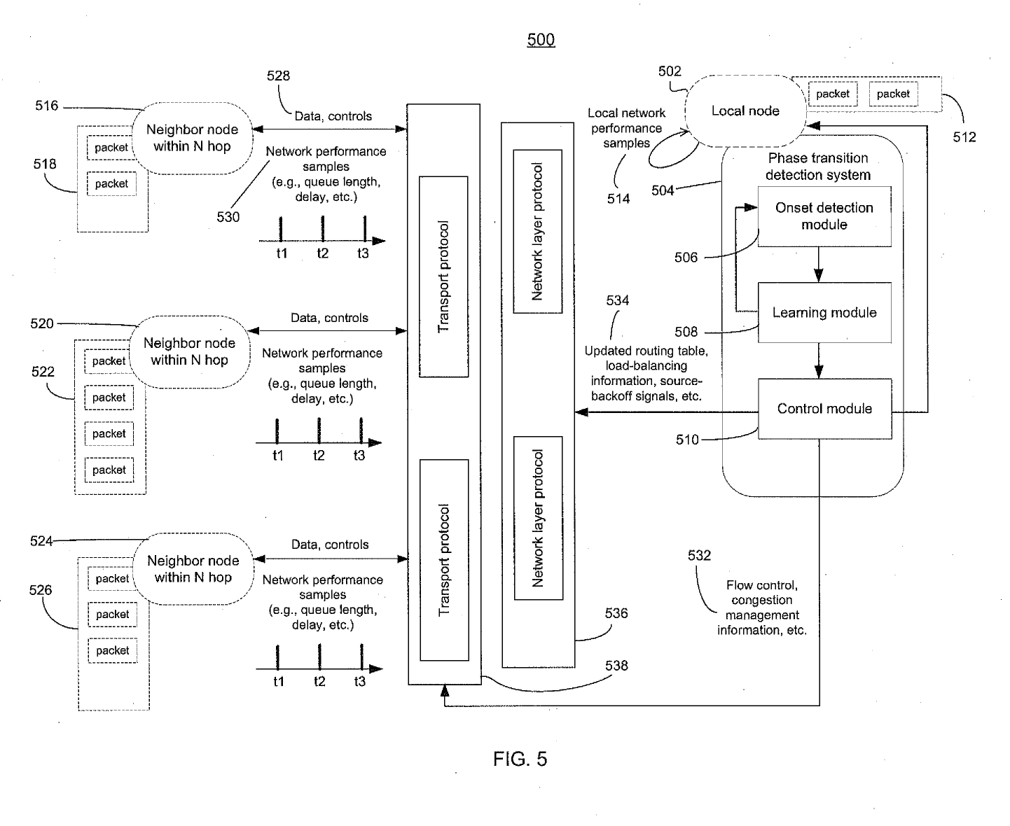

FIG. 5 illustrates a criticality-based control in accordance with aspects of the invention. In a homogeneous domain 500, network node 502, 516, 520 and 524 operate on network layer protocol 536 and transport protocol 538. Onset detection and control system 504 on node 502 may measure auto-correlation by sampling performance data 514 locally on network node 502. Such performance parameters may include queue-occupancy change in temporal dimension at a local buffer 512, where packets wait to be processed.

The onset detection and control system measures spatial-correlations and aggregate fluctuations of the domain based on performance data from nodes 516, 520 and 524, which are within N hop of node 502. Similar to the local measurements, the performance samples may include queue length fluctuations in temporal dimension in buffers associated with each network node (buffer 518, 522 and 526).

Onset detection module 506 performs threshold crossing detection and onset indicator processing functions, with feedbacks from learning module 508, including tuning of thresholds. The indicators generated by the detection module include aggregate queue-occupancy fluctuation versus per-node offered load.

As the traffic load increases in domain 500, the order parameter indicates when transition to congestion actually starts. From FIGS. 4A-C, it can be seen that the queue-occupancy fluctuation acts as advanced warning for the criticality where it grows before the average delay as the offered load approaches the criticality and reaches its maximum at the transition point. Thus, control module 510 can determine specific congestion and flow control signals to be sent based on the queue-occupancy fluctuation, as well as spatial-correlations and auto-correlations of the queue-occupancies.

The control module may include various state-of-art congestion management functions and flow control mechanisms. For example, a TCP congestion manager may be implemented based on the detected onset status and send signals 532 to control packet flow, retransmission, etc. Control signals 534 may include updated routing tables, source-backoff signals and dynamic load balancing instructions may also be sent to each measured node for routing path adjustment and link weights tuning to alleviate bottleneck situations.

The congestion and flow control may be configured to perform different control functions based on the closeness to congestion in a network domain. When the global phase of the domain is close to be, but not yet, congested, load may be balanced and packets may be re-routed through the newly selected paths to reduce local congestions. Local load balancing scheme may be selected to reduce the local gradient of queue lengths or concentration gradient of congested queues to a dynamically set or predetermined level by routing packets down such gradients.

When the domain is globally congested, the control system may perform admission control at source nodes and selective drop packets at intermediate queues based on priority and pre-emption information. The learning system may adopt reinforcement learning algorithms to assign rewards to congestion and non-congestion phases (e.g., indifferent if non-congested and heavy penalty if congested) and take weighted actions (e.g., different strengths of back-off and packet drop signals).

Learning system 508 may also build state-action pairs based on empirical data and take actions based on the transition probability from a state-action pair to another state. The system may adapt, over time, its action policy to reward distribution, network dynamism and measurement uncertainties. For example, the optimal policy should become more conservative and cause the network to stay further away from criticality when the penalty for criticality crossing, dynamism and measurement uncertainties increase.

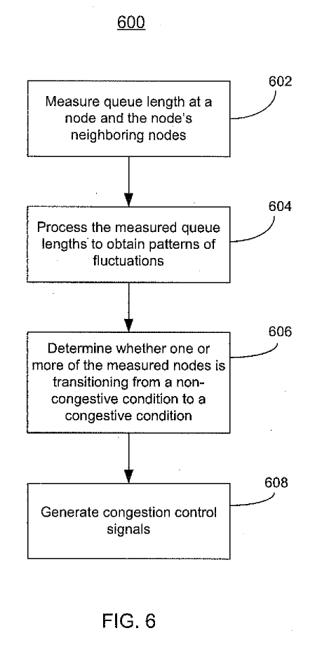

FIG. 6 is a flow chart in accordance with aspects of the invention. In block 602, the phase transition detection system at a node measures queue length at the node and the node's neighboring nodes. In block 604, the system processes the measured queue lengths to obtain patterns of fluctuations. Then, in block 606, the system determines whether one or more of the measured nodes are transitioning from a non-congestive condition to a congestive condition. Based on the determination, the system generates the congestion control signals in block 608 to route the network traffic away from the congestion points.

Besides the above-mentioned network centric control methods, criticality-based control may also be combined with source-centric control mechanisms such as network-utility maximization or sum-rate maximization. For example, in traditional network-utility maximization, each link continuously updates a link price based on the factors such as last link price, link utilization and internal state like queue lengths. Each source reacts by maximizing its own utility minus the current link price aggregated over its route. Network-utility maximization with criticality-based control may take into account the factor of proximity to local congestion or the local onset sign and updates the link price accordingly. The weight of this additional pricing signal may be defined through a reinforcement learning system.

As such, a network may be made to operate close to a congestion point yet staying in the non-congestive phase through onset detection and congestion management based on the detection. This helps the network to avoid the lengthy recovery time from congestion and at the same time operates with a high utilization rate. As generally known, the highest network utilization occurs immediately before the congestive criticality. Thus, by tuning and monitoring the pattern of network variable fluctuation through indicators such as correlation lengths, relaxation time, skewness and flickering, a network may operate near its full capacity without suffering from congestions.

It will be further understood that the sample values, types and configurations of data described and shown in the figures are for the purposes of illustration only. In that regard, systems and methods in accordance with aspects of the invention may be based on other network variables besides queue-length fluctuation and growth, and be used in different network architectures. The systems and methods may be provided and received at different times (e.g., via different servers or databases) and by different entities (e.g., some values may be pre-suggested or provided from different sources).

As these and other variations and combinations of the features discussed above can be utilized without departing from the invention as defined by the claims, the foregoing description of exemplary embodiments should be taken by way of illustration rather than by way of limitation of the invention as defined by the claims. It will also be understood that the provision of examples of the invention (as well as clauses phrased as “such as,” “e.g.”, “including” and the like) should not be interpreted as limiting the invention to the specific examples; rather, the examples are intended to illustrate only some of many possible aspects.

Unless expressly stated to the contrary, every feature in a given embodiment, alternative or example may be used in any other embodiment, alternative or example herein. For instance, various learning systems may be employed in any configuration herein. Existing or future network protocols may be used in any configuration herein. Any suitable congestion and flow control mechanisms may be used with any of the configurations herein.

1. A method of managing network congestion in a network including a plurality of network nodes, each node having one or more neighboring nodes and a buffer for queuing packets, the method comprising:
measuring queue length at a node and at, least one of the node's neighboring nodes;
processing the measured queue lengths to obtain one or more patterns of fluctuations;
determining whether one or more of the measured nodes are transitioning towards a phase transition point based on the one or more obtained patterns of fluctuations, the phase transition point corresponding to a change from a non-congestive condition to a congestive condition of the measured nodes; and
generating one or more congestion control signals based on the determination.

2. The method of claim 1, wherein measuring queue length further comprises sampling queue length at a predetermined sampling frequency within a predetermined time period.

3. The method of claim 2, wherein processing the measured queue length further comprises correlating the queue lengths of at least two of the nodes sampled at different time instances to obtain an auto-correlation of sampled queue lengths.

4. The method of claim 1, wherein measuring queue length at the at least one or more of the node's neighboring nodes comprises measuring queue length at one or more neighboring nodes within a predetermined or dynamically tuned hop distance to obtain a spatial correlation of the queue lengths measured at the one or more neighboring nodes.

5. The method of claim 4, wherein processing the measured queue lengths further comprises correlating the measured queue lengths of the node and the one or more neighboring nodes.

6. The method of claim 1, wherein processing the measured queue lengths further comprises obtaining aggregate fluctuations of the measured queue lengths, the aggregate queue-length fluctuation being measurable by a standard deviation divided by an average of the measured queue length.

7. The method of claim 6, wherein processing the measured queue lengths further comprises obtaining aggregate fluctuations of the rate of changes of the measured queue lengths.

8. The method of claim 1, wherein determining whether one or more of the measured nodes are having transition onsets comprises determining one or more predetermined thresholds for each respective one of the one or more obtained patterns of fluctuations.

9. The method of claim 8, further comprising dynamically tuning the predetermined thresholds based on an adaptive learning process.

10. The method of claim 8 wherein determining whether one or more measured nodes are transitioning comprises determining if averages of the patterns of fluctuation are above the predetermined thresholds.

11. A method of routing a packet in a network, the network including a plurality of network nodes, each node having one or more neighboring nodes and including a buffer for queuing packets to be transmitted and packets received from other network nodes, the method comprising:
measuring queue length at a first node and one or more neighboring nodes within a predetermined, or dynamically tuned, hop range of the first node;
processing the measured queue length to determine patterns of queue length fluctuations;
determining whether one or more of the measured nodes are in a transition status towards a phase transition point based on the determined fluctuations, the phase transition point corresponding to a change from a non-congestive phase of one or more of the monitored nodes to a congestive phase of one or more of the monitored nodes; and
selecting a routing path based on the determination.

12. A method of detecting network congestion, comprising:
monitoring at a first network node queue length data associated with one or more other network nodes in communication with the first network node;
determining at the first network node changes in queue lengths of the one or more other network nodes and the first network node;
correlating the changes in the queue lengths based on a time metric and a distance metric; and
determining that a network congestion condition exists if the correlated changes in queue length size exceed a predetermined threshold.

13. The method of claim 12, wherein the time metric comprises a time window including at least a first change in queue length at a first time and a second change in queue length at a second time.

14. The method of claim 12, wherein the distance metric comprises queue lengths of a plurality of other network nodes within a predetermined, or dynamically tuned, distance of the first node.

15. The method of claim 12, further comprises measuring aggregate fluctuation in the changes in queue lengths, wherein the aggregate fluctuation comprises of standard deviation divided by an average of the monitored changes in queue lengths.

16. The method of claim 12, further comprising transmitting a control signal from the first network node to the one or more other networks nodes indicating onset of a network congestion condition if the correlated changes in queue length size exceed the predetermined threshold.

17. The method of claim 12, further comprising dynamically tuning the predetermined threshold based on an adaptive learning process.

18. The method of claim 12, wherein the first network node is selected from the group consisting of a router and a computer.

19. A communication apparatus in a communication network, the communication network including a plurality of network nodes, wherein each respective one of the plurality of network nodes has one or more neighboring nodes and each respective node has a buffer for queuing packets, the communication apparatus is coupled to a first network node, the first network node being one of the plurality of network nodes, the communication apparatus comprising:
a processor;
a memory coupled to the processor and containing instructions executable by the processor; the instructions being executable to:
measure queue length at the first node and respective queue length at the first node's neighboring nodes;
process the measured queue lengths to obtain patterns of fluctuations for one or more of the measured queue lengths;
determine whether one or more of the measured nodes are transitioning towards a phase transition point based on the one or more obtained patterns of fluctuations, the phase transition point corresponding to a change from a non-congestive condition to a congestive condition of the measured nodes; and
generate one or more congestion control signals based on the determination.

20. The apparatus of claim 19 further comprising instructions executable to:
correlate queue lengths sampled at a predetermined sampling frequency at the first node;
correlate the measured queue lengths of the first node and those of its one or more neighboring nodes; and
obtain an aggregate fluctuation in the measured queue lengths.

21. The apparatus of claim 19, further comprising instructions executable to measure aggregate queue-length fluctuation as a standard deviation divided by an average of the measured queue lengths.

22. The apparatus of claim 19, further comprising instructions executable to determine if the obtained one or more patterns of fluctuations is each above a respective predetermined threshold.
